(19) United States
(12) Patent Application Publication
(10) Pub. No.: US 2012/0064468 A1
(43) Pub. Date: Mar. 15, 2012

(54) CONTAINER FOR CANDLE WITH MATCHES

(76) Inventor: David P. Sibley, Twin Falls, ID (US)

(21) Appl. No.: 13/233,953

(22) Filed: Sep. 15, 2011

Related U.S. Application Data
(60) Provisional application No. 61/383,013, filed on Sep. 15, 2010.

(51) Int. Cl. F23D 3/16; B65B 7/28; C11C 5/00; B65B 61/20

(52) U.S. Cl. 431/291; 53/474; 53/471

(57) ABSTRACT

The present invention provides a unique container for a candle with matches and a method of manufacturing an inexpensive canned candle by the use of conventional canning methods that can be stored for emergency and disaster situations for extended periods of time where the candle and a method of lighting them are easily available. The canned candle will be constructed of a container made from aluminum or steel that has been pressed formed in one piece. It will have a conventionally sealed pop-top lid used in the canning process of both foods and soft drinks, but not normally used in the process of manufacturing candles.

### FIELD OF THE INVENTION

The present invention provides a unique candle in a can product and an efficient method of manufacturing an inexpensive canned candle. The resulting candle with matches in a can is effective in storing the candle, keeping the matches dry and preserving the candle for disaster situations or normal applications.

### BACKGROUND OF THE INVENTION

Candles have become popular for decorative and utilitarian purposes for many years and as such have been formed in a wide variety different styles, shapes and colors. Typically, there are three different types of candles: tapered, molded, and in containers. The candles may be manufactured from wax such as paraffin wax, vegetable wax, or beeswax. A molded candle is formed by pouring molten wax into a mold containing a candle wick. The wax is allowed to cool such that it solidifies and the candle is removable from the mold thereby forming the candle. Tapered candles are formed by dipping a wick into molten wax. Each time the candle is dipped into the molten wax, the wax adheres to itself thereby forming the tapered candle. Candles in containers normally consist of glass jars with a seal that is a press fit between the inside upper surface of the glass jar and the lid. Candles in metal containers generally have a lid that slides over the upper edge of the container. The metal containers have a crimped lower rim attaching the bottom to the side walls that has the tendency to leak wax when the candle has burned down and the metal container has developed enough heat to melt the wax on the lower surface of the candle. The sealing method on the glass jars and the metal containers is not adequate enough to create a complete seal for an extended period of time. By using the conventional canning method described in this application for sealing the candles in a formed metal container with no crimped lower rim, no fragrances are inadvertently released and the candles may be kept for an extended period of time without the fragrance or candle degrading.

There has consistently been a need for a method of storing candles for emergency situations for extended periods of time where the candle and a method of lighting them are easily available. The use of these candles is very desirable in military issued supplies or for disaster relief supplies where they can withstand a great deal of abuse. These candles also can be used for nautical emergency supplies.

Numerous innovations for candles have been provided in the prior art that are described as follows. Even though these innovations may be suitable for the specific individual purposes to which they address, they differ from the present design as hereinafter contrasted. The following is a summary of those prior art patents most relevant to this application at hand; as well as a description outlining the difference between the features of the canned candle and the prior art.

U.S. Pat. No. 6,068,472 of Scott H. Freeman et al. describes a decorative candle. The candle comprises a container that defines an interior chamber. Disposed within the interior chamber is a candle core having a top surface, a bottom surface, an outer surface, and a bore. The candle core is disposed within the interior chamber such that the bottom surface of the candle core is in abutting contact with the container and a cavity is formed between the outer surface and the container. The candle further comprises a wick disposed within the bore of the candle core. Disposed within the cavity and bore is an outer layer of a wax mixture. The outer layer has a melting point less than the melting point of the candle core such that the outer layer can be poured over the candle core without melting the same. The candle further includes at least one component placed upon a top surface of the top layer. Additionally, a top layer of the wax mixture is disposed on the top surface of the outer layer. The top layer partially encapsulates the component and the wick. Preferably, the top layer has a melting point lower than the melting point of the component such that the component will not melt when the top layer is poured into the container.

This patent describes a decorative candle of a unique internal construction of the wax material but does not deal with the packaging of the canned candle or of having the book of matches sealed within the container.

U.S. Pat. No. 6,382,962 of Tod A. Papai tells of a venting cover for a containerized candle that stabilizes the combustion flame and improves the efficiency of the combustion of containerized candles is disclosed. The venting cover of this invention is a flat disc, which is seated over the mouth of the container or jar. The venting cover has an annular flange around its periphery, a central exhaust vent and six oblong inlet vents spaced radially from the exhaust vent around the periphery of the venting cover. The venting cover creates a concentric laminar air flow within the interior of the jar, which stabilizes the flame and improves the efficiency of the combustion.

This patent tells of a venting cover for a containerized candle that stabilizes the combustion flame but does not use the unique method of canning the candle in a conventional pop-top container.

U.S. Pat. No. 6,629,836 of Bruce Campbell describes a cap for a jar containing a candle. The cap includes a lid and a snuffer plug. The lid is non-metallic and has a single exhaust throughbore that extends axially and centrally therethrough. The snuffer plug is dimensioned to fit securely into the single exhaust throughbore in the lid. The lid is preferably made of a heat insulating material, such as glass, and is dimensioned to fit snugly onto/into the open top of the jar. The single exhaust throughbore in the lid is preferably approximately 1.5 inches in diameter. The lid may be fluted and either transparent or translucent to provide decorative light diffusion.

This patent describes a cap for a jar containing a candle but again does not use the unique method of canning the candle in a conventional pop-top container and does not mention storing candles for emergency situations for extended periods of time where the candle and a method of lighting them are easily available.

U.S. Pat. No. 7,377,772 of Gregory R. Thume et al. relates to a candle container with a holder and burn control cover. The burn control cover and holder are configured in such a manner to create air intake vents for more efficient burning of a candle. The burn control cover includes a lower ring and an exhaust hole. A removable fitment attaches to the burn control cover through the exhaust hole for safe shipping and sealing of the candle container. A wax warmer container may attach to the candle container for scent distribution.

This patent relates to a candle container with a holder and burn control cover but does not have the unique features of the canned candle where the matches are sealed within the container.

None of these previous efforts, however, provides the benefits attendant with the canned candle and achieves its intended purposes, objects and advantages over the prior art devices through a new, useful and unobvious combination of method steps and component elements at a reasonable cost to manufacture, and by employing readily available materials.

In this respect, before explaining at least one embodiment of the canned candle in detail it is to be understood that the design is not limited in its application to the details of construction and to the arrangement, of the components set forth in the following description or illustrated in the drawings. The canned candle is capable of having other embodiments and of being manufactured in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other canned candle for carrying out the several purposes of the present design. It is important, therefore, that the claims be regarded as including such equivalent construction insofar as they do not depart from the spirit and scope of the present application.

### SUMMARY OF THE INVENTION

The principal advantage of the canned candle is using a conventional pop-top means of sealing as a unique method of manufacturing candles.

Another advantage of the canned candle is that it made in a formed can with no crimped seal on the bottom.

Another advantage of the canned candle is having a book of matches sealed within the upper portion of the container.

Another advantage is having the option of having the book of matches sealed in a plastic wrapper.

Another advantage of the canned candle is having a cardboard insert between the lid and the matches.

Another advantage of the canned candle is having an optional second cardboard insert between the matches and the wax surface.

Another advantage of the canned candle is having a cardboard insert with a finger hole and being cut from the finger hole to the outside edge for ease of removal.

Another advantage of the canned candle is having a cardboard insert that can be used for advertising purposes.

Another advantage is that the canned candle can be kept for extended periods of time without any degradation.

Another advantage is by using the conventional canning method it greatly reduces the manufacturing costs of producing the product.

A further advantage of the canned candle is that when fragrances are used they cannot be detected from outside of the container.

These together with other advantages of the canned candle, along with the various features of novelty, which characterize the design, are pointed out with particularity in the claims annexed to and forming a part of this disclosure. For a better understanding of the canned candle, its advantages and the specific objects attained by its uses, reference should be made to the accompanying drawings and descriptive matter in which there are illustrated preferred embodiments of the canned candle. There has thus been outlined, rather broadly, the more important features of the design in order that the detailed description thereof that follows may be better understood, and in order that the present contribution to the art may be better appreciated. There are additional features of the canned candle that will be described hereinafter and which will form the subject matter of the claims appended hereto.

The preferred embodiment of the canned candle will be constructed of a container made from aluminum or steel that has been pressed formed in one piece with no crimped edge on the bottom surface. It will have a conventionally sealed pop-top lid used in the canning process of both foods and soft drinks, but not normally used in the process of manufacturing candles. The candle may be manufactured from wax such as paraffin wax, vegetable wax, or beeswax. A zinc wick is attached to a base plate and will extend through the center to above the surface of the wax. A book of matches is inserted on the surface of the wax and covered with a circular cardboard insert with a finger hole in the center and a slit from the finger hole to the outside edge for ease of removal. The book of matches can be packaged in a sealed plastic wrapping. An optional second circular cardboard insert with a finger hole in the center and a slit from the finger hole to the outside edge can additionally be placed between the wax surface and the book of matches to protect the matches from damage if the container is inadvertently exposed to enough heat to soften the wax. A variety of fragrances can be used in the waxes if desired.

With respect to the above description then, it is to be realized that the optimum dimensional relationships for the parts of this application, to include variations in size, materials, shape, form, function and manner of assembly and use, are deemed readily apparent and obvious to one skilled in the art. All equivalent relationships to those illustrated in the drawings and described in the specification intend to be encompassed by the present disclosure. Therefore, the foregoing is considered as illustrative only of the principles of the canned candle. Further, since numerous modifications and changes will readily occur to those skilled in the art, it is not desired to limit the design to the exact construction shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate the canned candle and together with the description, serve to explain the principles of this application.

FIG. 1 depicts a perspective view of the prior art of canned candles with the lid raised above the container.

FIG. 2 depicts a perspective view of the canned candle with the plastic lid raised above the container.

FIG. 3 depicts a cross section view of the canned candle illustrating the internal components.

FIG. 4 depicts a cross section view of one side of the upper edge of the canned candle.

FIG. 5 depicts a perspective view of the circular piece of cardboard with a finger hole in the center and a slit from the finger hole to the outside edge.

For a fuller understanding of the nature and advantages of the canned candle, reference should be had to the following detailed description taken in conjunction with the accompanying drawings which are incorporated in and form a part of this specification, illustrate embodiments of the design together with the description, serve to explain the principles of this application.

### DETAILED DESCRIPTION OF THE PREFERRED EMBODIMENTS

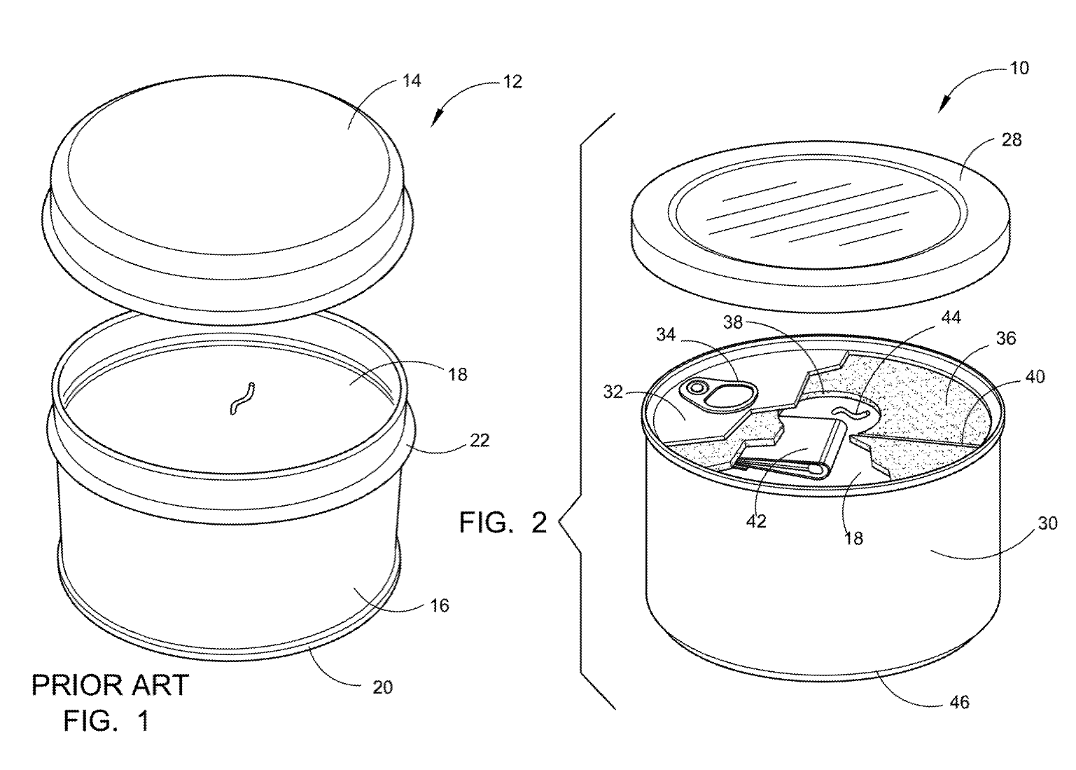

Referring now to the drawings, wherein similar parts of the canned candle 10 are identified by like reference numerals, there is seen in FIG. 1 a perspective view of the prior art of a canned candle 12 with the prior art lid 14 raised above the prior art container 16 holding the conventional wax material 18. The illustration further depicts the crimped bottom edge 20 and the formed lid retainer ring 22 on the side of the prior art container 16.

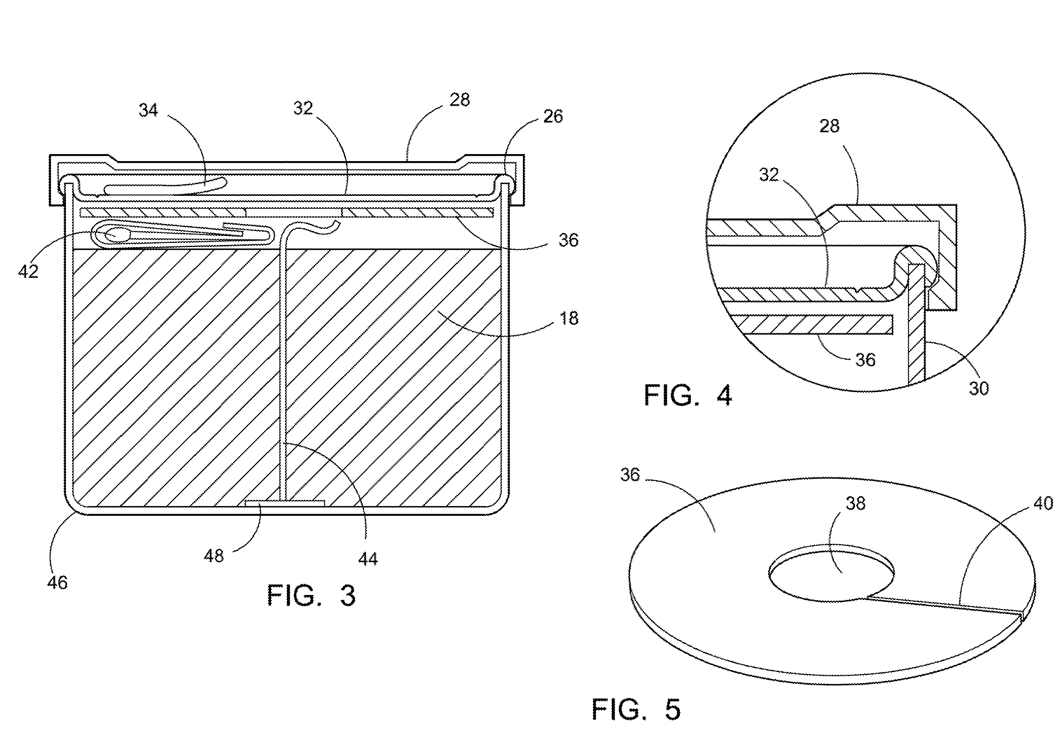

FIG. 2 depicts a perspective view of the canned candle 10 with the plastic lid 28 above the candle container 30. The conventional pop-top lid 32 with the opening tab 34 has been broken away to show the circular cardboard insert 36 with a finger hole 38 in the center and a slit 40 from the finger hole 38 to the outside edge for ease of removal. The circular cardboard insert 36 is additionally broken away to show the book of matches 42, the zinc candle wick 44 and the conventional wax material 18. The candle container 30 has been pressed formed producing a smooth contoured lower edge 46. The preferred embodiment of the canned candle 10 will be constructed of a container made from aluminum or steel that has been pressed formed in one piece 30 with no crimped edge on the bottom surface. It will have a conventionally sealed pop-top lid 32 used in the canning process of both foods and soft drinks, but not normally used in the process of manufacturing candles. The candle may be manufactured from wax such as paraffin wax, vegetable wax, or beeswax. A zinc wick 44 is attached to a base plate 48 (see FIG. 3) and will extend through the center to above the surface of the wax. A book of matches is inserted on the surface of the wax and covered with a circular cardboard insert with a finger hole in the center and a slit from the finger hole to the outside edge for ease of removal. The book of matches 42 can be packaged in a sealed plastic wrapping (not shown). An optional second circular cardboard insert (not shown) with a finger hole in the center and a slit from the finger hole to the outside edge can additionally be placed between the wax surface and the book of matches to protect the matches from damage if the container is inadvertently exposed to enough heat to soften the wax. A variety of fragrances can be used in the waxes if desired.

FIG. 3 depicts a cross section view of the canned candle 10 illustrating the internal components with the conventional pop-top lid 32 with the opening tab 34 and the circular cardboard insert 36, the book of matches 42, the zinc candle wick 44 and the conventional wax material 18. The candle container 30 has been pressed formed producing a smooth contoured lower edge 46. The upper lid includes the pop-top opening tab 34 and has a crimped edge 26. Wick 44 has a wick base 48, and this wick base 48 may be optionally affixed to the contoured lower edge 46 of the can.

FIG. 4 depicts a cross section view of one side of the upper edge of the canned candle container 30 more clearly illustrating the location of the plastic lid 28, the pop-top lid 32.

FIG. 5 depicts a perspective view of the circular cardboard insert 36 with a finger hole 38 in the center and a slit 40 from the finger hole 38 to the outside edge.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

I claim:

1. A container for a candle comprising:
(a) a candle having a wick and a wick base;
(a) a press formed can for containing said candle;
(b) a lid forming an airtight seal having a pop-top opening means thereon;
(c) a book of matches disposed within said press formed can adjacent to said candle; and
(d) a circular cardboard insert having a finger hole and a slit therein.

2. The container for candle according to claim 1, wherein said candle is made from conventional wax material, including paraffin wax, vegetable wax, and beeswax.

3. The container for candle according to claim 1, wherein said wick comprises a zinc wick.

4. The container for candle according to claim 1, wherein said container further includes a plastic lid for use in sealing the candle container after said pop-top lid is removed from the container.

5. The container for candle according to claim 1, wherein said lid having a pop-top opening means thereon includes an opening tab.

6. The container for candle according to claim 1, wherein said lid having a pop-top opening means thereon includes a crimped edge.

7. The container for candle according to claim 1, wherein said wick and wick base may be optionally affixed to the contoured lower edge of the can.

8. The container for candle according to claim 1, wherein said book of matches is packaged within a sealed plastic wrapping before being sealing inside the container.

9. The container for candle according to claim 1, further including an optional second circular cardboard insert with a finger hole in the center and a slit from the finger hole to the outside edge can additionally be placed between the wax surface and the book of matches to protect the matches from damage if the container is inadvertently exposed to enough heat to soften the wax.

10. The container for candle according to claim 1, wherein said circular cardboard insert is disposed between said book of matches and said pop-top lid within the container.

11. A method for making a container for a candle, comprising the steps of:
(a) providing a candle having a wick and a wick base;
(a) providing a press formed can for containing said candle;
(b) providing a lid forming an airtight seal having a pop-top opening means thereon;
(c) providing a book of matches disposed within said press formed can adjacent to said candle; and
(d) providing a circular cardboard insert having a finger hole and a slit therein.

12. The method for making a container for candle according to claim 11, wherein said candle is made from conventional wax material, including paraffin wax, vegetable wax, and beeswax.

13. The method for making a container for candle according to claim 11, wherein said wick comprises a zinc wick.

14. The method for making a container for candle according to claim 11, wherein said container further includes a plastic lid for use in sealing the candle container after said pop-top lid is removed from the container.

15. The method for making a container for candle according to claim 11, wherein said lid having a pop-top opening means thereon includes an opening tab.

16. The method for making a container for candle according to claim 11, wherein said lid having a pop-top opening means thereon includes a crimped edge.

17. The method for making a container for candle according to claim 11, wherein said wick and wick base may be optionally affixed to the contoured lower edge of the can.

18. The method for making a container for candle according to claim 11, wherein said book of matches is packaged within a sealed plastic wrapping before being sealing inside the container.

19. The method for making a container for candle according to claim 11, further including an optional second circular cardboard insert with a finger hole in the center and a slit from the finger hole to the outside edge can additionally be placed between the wax surface and the book of matches to protect the matches from damage if the container is inadvertently exposed to enough heat to soften the wax.

20. The method for making a container for candle according to claim 11, wherein said circular cardboard insert is disposed between said book of matches and said pop-top lid within the container.
